(19) United States
(12) Patent Application Publication
(10) Pub. No.: US 2025/0383465 A1
(43) Pub. Date: Dec. 18, 2025

(54) MACHINE LEARNING CHANNEL FACIES TREND MAPPING

(71) Applicant: Saudi Arabian Oil Company, Dhahran (SA)

(72) Inventor: Lundi Kusuma, Dhahran (SA)

(21) Appl. No.: 18/743,498

(22) Filed: Jun. 14, 2024

(51) Int. Cl. G01V 1/46; E21B 7/04; E21B 47/12; G06T 7/00

(52) U.S. Cl. CPC G01V 1/46; E21B 7/04; E21B 47/12; G06T 7/0004

(57) ABSTRACT

Disclosed are methods, systems, and computer-readable medium to perform operations including: obtaining geological composition data from at least one drilled well within a geographical area; generating preprocessed data using at least one of (i) the obtained geological composition data or (ii) an image representing the geographical area that preserves first spatial data; providing the preprocessed data to one or more machine learning models, wherein the one or more machine learning models are trained to predict trend mappings of facies using second spatial data or location-based data; and controlling a drilling mechanism using the output of the one or more trained machine learning models.

### TECHNICAL FIELD

This disclosure relates to hydrocarbon exploration, drilling, and production, and more particularly, to mapping channel facies for optimizing drilling and maximizing hydrocarbon recovery.

### BACKGROUND

Hydrocarbon exploration and drilling is the process of searching for and extracting hydrocarbons, such as petroleum and natural gas, from the Earth's crust. The exploration process can include detecting and determining an extent of hydrocarbon deposits using exploration geophysics. This can include detecting large-scale features of the sub-surface geology. When a prospect has been identified, evaluated, and passes selection criteria, an exploration well can be drilled to determine the presence or absence of oil or gas.

### SUMMARY

Techniques described include training and using one or more machine learning models to predict the locations of facies within an area. Facies can include sand facies that typically hold hydrocarbons. Output from trained models can be used to control drilling mechanisms to optimize drilling operations—e.g., by drilling in regions where hydrocarbons are likely to be stored in the ground.

In general, one aspect of the subject matter described in this specification can be embodied in methods that include the actions of obtaining geological composition data from at least one drilled well within a geographical area; generating preprocessed data using at least one of (i) the obtained geological composition data or (ii) an image representing the geographical area that preserves spatial information; providing the preprocessed data to one or more machine learning models, wherein the one or more machine learning models are trained to predict trend mappings of facies using spatial data or location-based information; and controlling a drilling mechanism using the output of the one or more trained machine learning models.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. Feature 1: Obtaining the geological composition data from the at least one drilled well within the geographical area comprises: obtaining data collected during or after drilling in the geographical area. Feature 2: Generating the preprocessed data comprises: generating a structured data container with two data dimensions, wherein the two dimensions match the dimensions of the image representing the geographical area; sampling values from at least one of (i) the obtained geological composition data or (ii) the image representing the geographical area; and generating values for each of element of the generated structured data container using the sampled values from at least one of (i) the obtained geological composition data or (ii) the image representing the geographical area. Feature 3: Generating the preprocessed data comprises: determining a quality of the image representing the geographical area; and adjusting, based on the determined quality, the image representing the geographical area. Feature 4: Controlling the drilling mechanism using the output of the one or more trained machine learning models comprises: providing data indicating the output of the one or more trained machine learning models to one or more computers controlling the drilling mechanism. Feature 5: Controlling the drilling mechanism using the output of the one or more trained machine learning models comprises: adjusting a steering direction or operation of the drilling mechanism using the output of the one or more trained machine learning models. Feature 6: Actions include training the one or more machine learning models to predict trend mappings of facies using ground truth data generated by object modeling. Feature 7: The second spatial data includes the first spatial data.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE DRAWINGS

FIG. 1 illustrates an example system for machine learning channel facies trend mapping.

FIG. 2 illustrates an example method, according to some implementations.

FIG. 3 is a partial schematic perspective view of an example rig system for drilling and producing a well, according to some implementations.

FIG. 4 illustrates example hydrocarbon production operations.

FIG. 5 is a block diagram of an example computer system, according to some implementations.

Like reference numbers and designations in the various drawings indicate like elements.

### DETAILED DESCRIPTION

The following detailed description describes systems and methods for machine learning channel facies trend mapping. Various modifications, alterations, and permutations of the disclosed implementations can be made and will be readily apparent to those skilled in the art, and the general principles defined may be applied to other implementations and applications without departing from the scope of the disclosure. Thus, the present disclosure is not intended to be limited to the described or illustrated implementations, but is to be accorded the widest scope consistent with the principles and features disclosed.

Techniques include using machine learning models to map trends of channel facies. In some cases, neural network-based machine learning models can predict geological facies trends within a two-dimensional container corresponding to input data that includes a two-dimensional image—e.g., an image representing a geographical area. Techniques include using one or more neural networks with customized activation functions to perform modeling of channel facies. Neural networks can predict the spatial trend of channel facies within a geographical area.

Mapping trends of geological facies can be used to identify areas of hydrocarbon reservoirs. In particular, a sand facies can indicate a region of hydrocarbon storage as sand facies tend to be more porous than other facies and can store hydrocarbon more readily. In some cases, facies can be classified into different patterns, e.g., straight, sinuous, meandered channel, and braided. For example, one or more machine learning models can classify facies as different patterns. Facie classification can give information of a geological condition.

In some cases, facie classification can affect downstream processes. For example, using a channel facies mapping, well plans can be generated that follow a channel facies shape, e.g., a well can be drilled to hit a targeted channel facies. A drilling rig can use generated facie information, e.g., facie location or classification, to steer or direct drilling to effectively hit one or more channel facies.

Input data to one or more neural networks that predict facies can include well data, image data, or a combination of both among others. In examples, well data includes seismic data. Well data can also include information representing the geological composition within an area—e.g., sand facies. However, seismic data typically does not have sufficient resolution to extract facies information and well data indicating geological composition can be limited to wells previously drilled. In some cases, seismic data lacks sufficient resolution at least because seismic resolution typically has coarse vertical resolution, which is used to compare well data. If there are channel facies with a thickness less than the seismic resolution, the seismic data might not show these channel facies. For example, a coarse vertical resolution of seismic data used to detect a geological object can be thirty feet. If there is a channel with a thickness of twenty feet, then the seismic data might not show this channel. On the other hand, well data typically has a more fine resolution. For example, core data or well log data can be captured at a 0.5 feet thickness.

The techniques described use, at least in part, partial forms of data characterizing a surface or subsurface to predict facies using trend mapping. In some cases, the partial forms of data can be well data, image data, or seismic data. In some cases, seismic data is not used. In some cases, partial data is combined to increase robustness or effectiveness of one or more machine learning models configured to process the partial data—e.g., well data, image data, or seismic data can be sampled to generate a grid of input data that is provided as input data to one or more machine learning models. In examples, partial data refers to incomplete data sets—e.g., data that only partially indicates geological composition within a region. By sampling the data into a structured data format instead of an image pixel format, processing efficiency of the one or more machine learning models can be increased.

One or more neural networks can be used to map channel facies trends by predicting composition of material between regions where the composition is known—e.g., indicated by well data. In some cases, one or more machine learning models can be generated using a set of input data. The one or more trained machine learning models can then predict channel facies trends based on only a subset of that set of input data—e.g., only image data without additional seismic or well data for a given area. Techniques can include predicting channel facies trend mapping or other mappings. Predicting a mapping can include predicting geological facies, geological facies trends, composition of material between regions, or a combination of one or more of these among others.

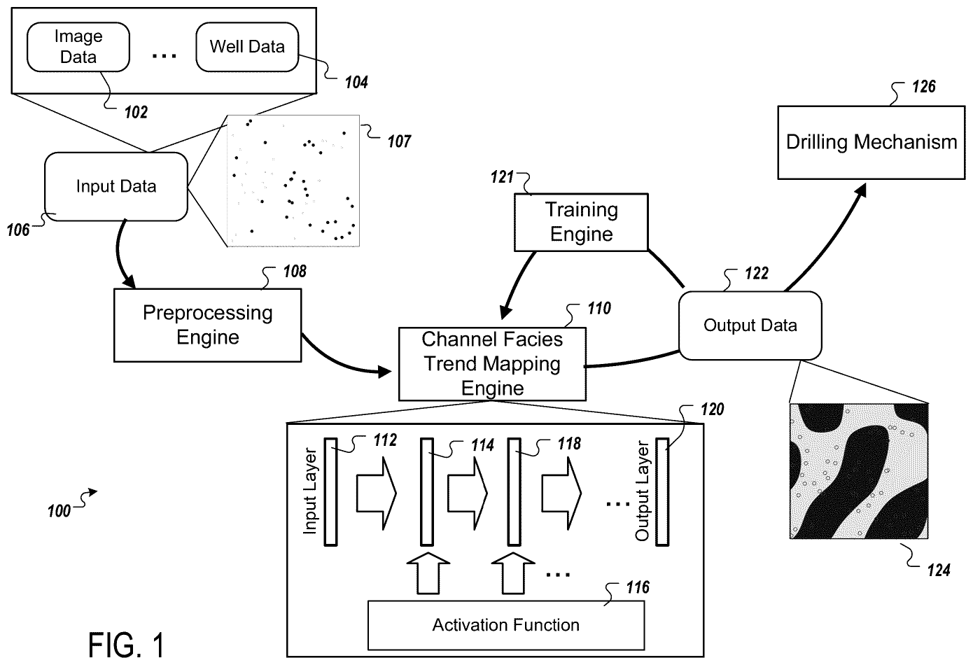

FIG. 1 shows an example system 100 for machine learning channel facies trend mapping. The system 100 includes a preprocessing engine 108, a channel facies trend mapping engine 110, a training engine 121, and a drilling mechanism 126. The system 100 can use input data 106 to generate output data 122. The output data 122 can include a representation of channel facies for a given area—e.g., a two-dimensional area at a given depth under a geological surface or at a geological surface. The system 100 can include the drilling mechanism 126 that uses the output data 122 to perform one or more drilling operations—e.g., as described in this application.

The preprocessing engine 108 of the system 100 can obtain the input data 106. The input data 106 can include one or more different types of data, e.g., image data 102 or well data 104. In some cases, the image data 102 includes a red green blue (RGB) image or other image, such as an image in JPEG, PNG, BMP, or other format. In some cases, the image data 102 includes data extracted from an image, such as extracting each of one or more classifications per pixel based on pixel values of the image. Each class can be represented by a numerical value, e.g., 72 corresponding to geological composition and 73 corresponding to another geological composition represented in the image. In some cases, a camera is used to capture the image data 102. In some cases, the image data 102 is provided through annotation of data representing one or more geological compositions by a composition model or human expert.

The image data 102 can represent a geological feature or data within a specific surface or subsurface area. The image data 102 can represent soil with gradations of color indicating potential facies. The well data 104 can include seismic data or other data collected during or after drilling in a particular area. The area represented by the well data 104 can include an area represented by at least a portion of the image data 102. The area for which the system 100 can generate the output data 122 that predicts channel trend mappings can include an area represented by both the well data 104 and the image data 102.

The preprocessing engine 108 of the system 100 can preprocess the input data 106 and provide preprocessed data to the channel facies trend mapping engine 110 for further processing and generation of the output data 122. In some cases, the preprocessing engine 108 can convert the image data 102 into a structured dataset. Preprocessing the image data 102 into a structured dataset can improve efficiency of one or more machine learning models, such as the channel facies trend mapping engine 110, by, e.g., reducing a number of processes required by the models within one or more layers of the models. An image can include a collection of pixels arranged in a grid with each pixel including color information. Without additional structure or metadata, an image does not represent a structured dataset. Rather, it requires interpretation by specialized processes to extract information from it. An image can be categorized as unstructured data because it lacks a predefined organization or format, e.g., for geological composition data, to facilitate efficient processing. Structured data can be organized into tables or databases with defined fields and relationships. Structured data can facilitate efficient processing, e.g., by reducing a number of intermediate processes in one or more models to transition from input data provided to the model to intermediate data ready for processing. In some cases, the number of intermediate processes can be zero. Intermediate processes performed before machine learning model processes is preferable because it allows the model to be less complex which increases robustness, reduces training time, and can improve accuracy.

In some cases, the image data 102 includes values indicating geological composition. For example, the image data 102 can include a matrix of values in two-dimensions where each value in the image data 102 represents whether a pixel belongs to one or more categories. Each category can represent a particular geological composition—e.g., sand, shale, among others. The preprocessing engine 108 can convert the two-dimensional matrix into a tabular form where each entry in the tabular form includes values corresponding to x and y coordinates or i and j coordinates and a classification of the given pixel.

In some cases, the preprocessing engine 108 can process the well data 104. For example, the preprocessing engine 108 can generate a set of pixels corresponding to the image data 102 and add, for one or more pixels of the image data 102, information included in the well data 104. The preprocessing engine 108 can add seismic information or composition information for one or more pixels included in the image data 102—e.g., using previous measurements obtained by one or more connected components of the system 100. In some cases, the information can include a Boolean value indicating whether or not the pixel corresponds to sand facies. In some cases, the input data 106 represents a sparse dataset from which the channel facies trend mapping engine 110 can generate the output data 122. In some cases, the preprocessing engine 108 samples a vertical or horizontal axis across the image data 102 to generate values for a two-dimensional grid container that forms the structured data set to be provided to the channel facies trend mapping engine 110. In some cases, iterative sampling across axes of the image data 102 can help preserve the orientation of the image data 102 in the structed data output. Sampling into a grid representing structed data can also reduce data storage requirements for the image data 102—e.g., by removing extraneous pixel information and retaining geological composition classification data within two a two-dimensional region.

Sampling from an image to create a two-dimensional table with geological composition data can be different than simply adding parameter values to each pixel of the image. Adding parameter values to each pixel only adds a channel of information to the image file but the image format remains unstructured. Without sampling from the image, the image typically must be processed as an image in a computer vision domain with associated computer resource requirements and a deep learning model architecture that requires large training data sets (e.g., one million images). By sampling, the preprocessing engine 108 can improve efficiency and robustness of the model, e.g., the channel facies trend mapping engine 110 where an incorporated model can map or predict properties in regions between sampled data, such as well data within a region.

A graphical representation of the input data 106 is shown in item 107. The representation includes markers within an area at a given depth or at a surface. The markers represent a well that includes at least one geological composition from among one or more geological compositions, e.g., sand or shale.

In some cases, preprocessing includes determining an image quality of the input data 106. For example, the preprocessing engine 108 can determine, using the input data 106, if a background color exists or if there is discretion in color or color gradation. In general, the preprocessing engine 108 can remove background, e.g., non well sampling data. For example, if the input data 106 does not include points of data but rather regions of data, the preprocessing engine 108 can remove portions of regions and retain sampling points, similar to the points shown in item 107. Image quality can refer to a contrast or sharp distinctive color between sampling data and background data where the preprocessing engine 108 can help ensure there is no gradation color between sampling and background color.

In some cases, an image, such as the image data 102, e.g., used for sampling to generate the input data 106, can be an RGB image or other form of image. The image can be a snapshot of a computer monitor, e.g., displaying geoscience mapping software. The image can be from a printed paper map, manual hand drawing, or satellite image. The image can have well sampling information associated with it that can be added, e.g., by the preprocessing engine 108.

An image can include different colors or values in a single color image, such as a black and white image, that indicate geological composition. In some cases, geological composition is obtained and recorded in the input data 106 before processing. In some cases, only a numerical indication of geological composition is obtained and recorded in the input data 106 before processing—e.g., later classification can indicate which numerical values correspond to which geological compositions.

The channel facies trend mapping engine 110 obtains the preprocessed data from the preprocessing engine 108. The channel facies trend mapping engine 110 can include one or more machine learning models. For example, the channel facies trend mapping engine 110 can include a neural network that includes an input layer 112 and an output layer 120. The channel facies trend mapping engine 110 can provide the preprocessed input data to the input layer 112 and obtain output from the output layer 120 as the output data 122.

The neural network can include one or more hidden layers—e.g., layer 114 and 118. The neural network can include an activation function 116. In some cases, the activation function 116 is a customized function to help predict the output data 122. The customized function can include a sinusoidal function.

In some cases, the customized function is included with an additional non-linearity function to perform the activation function 116. Using a sine or cosine function can improve the natural geological composition predictions because, in nature, geological channel shapes typically follow specific patterns—e.g., forms of straight or curved shapes—that can be represented by sinusoidal functions.

A sinusoidal function can represent the shapes of channel facies better than other methods, such as interpolation, while using less compute resources compared to object modeling or geostatistical models that can require complex conceptual geological models (e.g., shapes of facies channel, such as width, length, amplitude, wavelength which can also be biased based on human interpretation leading to error) and complex geostatistical analysis (e.g., variogram analysis with uncertainty process).

In some cases, the channel facies trend mapping engine 110 is trained using a training engine 121. For example, the training engine 121 can obtain the output data 122, or previously generated output, and compare the output to ground truth data. For example, the training engine 121 can compare output to known trend mappings of channel facies. The training engine 121 can generate one or more values representing a difference between the output and the ground truth data. The training engine 121 can use the one or more difference values to adjust one or more parameters of one or more models of the channel facies trend mapping engine 110, such as one or more hyperparameters. In some cases, during hyperparameter tuning, sigmoid, Relu, Tanh, Sine activation function can be set in hidden layer and output layers. The number of neurons per hidden layer can be varied from 10 to 100,000. The number of epochs can range, e.g., from 10 to 100.The optimizer can include one or more of SGD, RMSprop, Adam, Adagrad, Adamax, Nadam. In some cases, an activation function can be sine in a hidden layer and sigmoid in an output layer. In some cases, a number of neurons per hidden layer can be large (e.g., 100,000) to allow for more complex representations of geological elements. In general, more neurons can provide more continuity, e.g., to channel sand. In some cases, a number of hidden layers is 1, which can help capture complex patterns with a high number of neurons (e.g., creating a wide but not deep neural network architecture). In some cases, 50 epochs are used, e.g., to ensure sufficient training time without overfitting and respecting well sampling. In some cases, an Adam type optimizer is used, which can provide adaptive learning rates that increase efficiency and performance. An example set of hyperparameters that can be used in the channel facies trend mapping engine 110 is included in the following table. In some cases, hyperparameter values can help generate more robust and accurate model output—e.g., reducing error rate and improving overall performance compared to pre-tuned hyperparameters. In some cases, other hyperparameters are used or other values for the same hyperparameters are used.

| | Before (During | Final |
|---|---|---|
| | Hyperparameter Tuning) | Hyperparameter |
| Hyperparameters | Type/Value | Type/Value |
| Activation Function | Sigmoid, Relu, Tanh, Sine | Sine |
| @ Hidden Layer | | |
| Activation Function | Sigmoid, Relu, Tanh, Sine | Sigmoid |
| @ Output Layer | | |
| Neuron | 10-100,000 | 100,000 |
| Hidden Layer | 1-10 | 1 |
| Epoch | 1-100 | 50 |
| Optimizer | SGD, RMSprop, Adam, | Adam |
| | Adagrad, Adamax, Nadam | |
| Loss | Hinge, Squared Hinge, | Binary |
| | Log-Cosh, Kullback-Leibler | crossentropy |
| | Divergence, Binary | |
| | crossentropy | |
| Evaluation Metrics | Loss, Accuracy | Loss = close to 0, |
| | | Accuracy = 1 |
| Backpropagation | Yes | Yes |
| Learning rate | 0.00001-10 | 0.001 |
| Decay | 0 | 0 |
| beta_1 | 0.9 | 0.9 |
| beta_2 | 0.999 | 0.999 |
| epsilon | 1.00E−07 | 1.00E−07 |

In some cases, the Activation Function@Hidden Layer can be set to sine, e.g., based on geological structure that can be well approximated using a curvature based on a sinusoidal wave. In some cases, the Activation Function@Output Layer can be set to sigmoid, e.g., to differentiate 0 and 1 as a binary classification, such as classifying one region as including a first geological composition and another region as included a second, different, geological composition. In some cases, the hyperparameter neuron represents a number of neurons used in a model, such as the model included in the channel facies trend mapping engine 110. In general, more neurons can give more continuity to channel sand. In some cases, the number of neurons can satisfy 1% of number pixels included in the image data 102 which can help reveal continuity of a geological composition—e.g., if the image data 102 includes 608,625 pixels, the number of neurons can include at least 1% or at least 6086 pixels. One hundred thousand satisfies the 1% threshold. In some cases, the hidden layer hyperparameter represents how many hidden layers are included in a model. In the above table, there is one hidden layer which, combined with a larger number of neurons (e.g., 100,000) can offer improvements for generating complex patterns while also reducing the depth of the network which can help reduce process requirements and training data. In some cases, 50 epochs are used, e.g., to iteratively train a model, such as a model included in the channel facies trend mapping engine 110. In some cases, the Adam optimizer is used which can be efficient to mimic channel like shape. In some cases, loss used to train a model can include predicting a region as including a geological composition and comparing the prediction to ground truth data. Loss close to 0 can include loss satisfying a threshold value, such as 0.01 or other value.

The ground truth data can be generated using channel object modeling using subsurface geological software. This method can provide accurate channel estimation but at the cost of additional compute resources. In general, object modeling requires complex, and computing resource intensive, processes. Use of object modeling for repeated geological composition prediction, including prediction used for drill guidance, can be resource cost prohibitive. It can also require expert geological understanding for a given region, e.g., known width of facies channel, length of the channel with respect to a maximum distance of the channel's axis. This information is typically not available based on subsurface data, such as well data. This information can be approximated by experts but can be subject to inaccuracies or bias. While such inaccuracies or bias can be temporarily incorporated into a model (e.g., included in the channel facies trend mapping engine 110), the model can be iteratively trained to remove inaccuracies or biases based on real time feedback—e.g., drill measurements in a predicted region either confirming or not confirming model predictions of geological composition.

Training can include no normalization or no standardization for spatial features. By not normalizing or standardizing, training can preserve two-dimensional spatial domain information. In some cases, preserving spatial information maintains a relationship in space between two or more datapoints or features. In some cases, a target value can be normalized—e.g., output can be 0 or 1 based on classification of geological composition or other normalized values. Training can include using a target value (such as a facies channel) and spatial features (i, j coordinate) to ensure model is predicting in a spatial domain. In some cases, probability of a neural network is discretized, e.g., a cut off of 0.5 can be implemented to get facies classification between two geological compositions, such as channel sand and shale.

The channel facies trend mapping engine 110 provides the output data 122 to the drilling mechanism. For example, the output data 122 can include a representation of channel facies—e.g., as shown in item 124 including, at least, a region of one geological composition and another region of another geological composition. The drilling mechanism 126 can use the output data 122 to optimize drilling. In some cases, the output data 122 can be used to plan well locations to drill channel oil or gas bearing reservoir rock. In some cases, the output data 122 can be used for vertical well drilling for real time drilling operation. For example, the system 100 can generate one or more predictions of channel trend mappings associated with facies at different depths. The collection of channel facies can then be used to steer a drill to penetrate a given region of each predicted channel trend mappings associated with facies at each depth—e.g., following a channel through the soil.

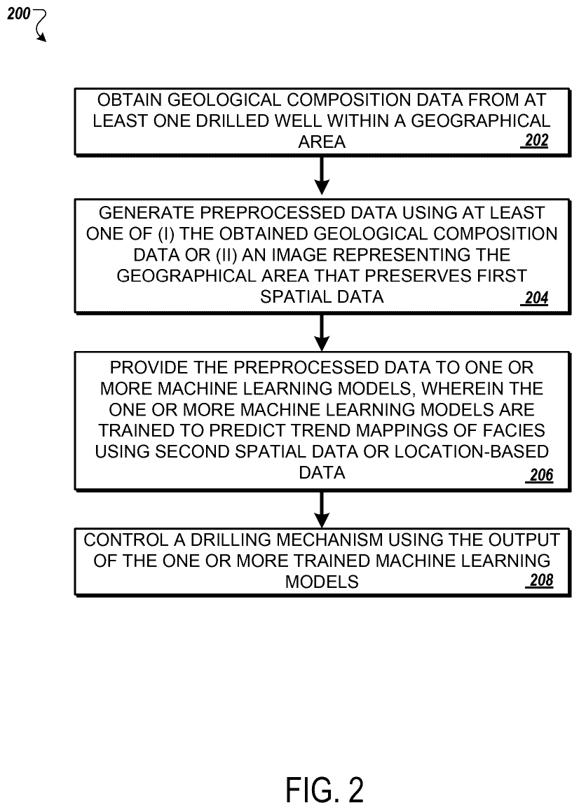

FIG. 2 illustrates a flowchart of an example method 200, according to some implementations. For clarity of presentation, the description that follows generally describes method 200 in the context of the other figures in this description. For example, method 200 can be performed by the system 100 of FIG. 1. It will be understood that method 200 can be performed, for example, by any suitable system, environment, software, hardware, or a combination of systems, environments, software, and hardware, as appropriate. In some implementations, various steps of method 200 can be run in parallel, in combination, in loops, or in any order.

The method 200 includes obtaining geological composition data from at least one drilled well within a geographical area (202). For example, the system 100 can obtain the image data 102 and the well data 104. The well data 104 can include geological composition data from at least one drilled well within a geographical area. The geological composition data can include an indication of which composition exists at a given depth—e.g., 20 meters below the surface the geological composition can be sand while 30 meters below the surface the composition can be shale.

The method 200 includes generating preprocessed data using at least one of (i) the obtained geological composition data or (ii) an image representing the geographical area that preserves first spatial data (204). For example, the preprocessing engine 108 of the system 100 can preprocess the input data 106. In some cases, the preprocessing engine 108 can preprocess the input data 106 by sampling data from the input data 106 and generating a two-dimensional structured dataset. In some cases, the image representing the geographical area includes a satellite image or image captured from geological modeling software.

The method 200 includes providing the preprocessed data to one or more machine learning models, wherein the one or more machine learning models are trained to predict channel trend mappings associated with facies using second spatial data or location-based data (206). For example, the preprocessing engine 108 can provide preprocessed data to the channel facies trend mapping engine 110 which can include one or more machine learning models. The one or more models can be trained using the training engine 121, e.g., using ground truth data, such as using spatial data, location-based information, or data generated by object modeling. In some cases, training by the training engine 121 includes adjusting one or more hyperparameters as discussed. Spatial data or location-based information can include oil and gas fields datasets, e.g., data indicating discovered hydrocarbons, fields under development, producing fields, or fields that have ceased production. Attributes can include discovery year, hydrocarbon type, status, or description. Spatial data or location-based information can include borehole or well datasets, e.g., data indicating oil wells, gas wells, geothermal wells, or stratigraphic boreholes. Well headers can include parameters that describe a borehole's location, purpose, result, or current status. Spatial data or location-based information can include seismic surveys, such as 2D or 3D seismic surveys, e.g., that indicate subsurface geological structures or hydrocarbon indicators. Spatial data or location-based information can include data from geographic information systems (GIS). Spatial data or location-based information can include one or more images that can be either georeferenced or non-georeferenced. A georeferenced image can follow geographic coordinate system where a non-georeferenced image can follow local coordinate system, e.g., that can be in i, j coordinates or be part of grid-based system.

In some cases, training one or more models of the channel facies trend mapping engine 110 includes training that incorporates at least some geological composition data and at least some image data, where partial data can be combined into a structure dataset prior to machine learning processing for increased efficiency. For runtime use of the trained model, only one of geological composition data or image data is needed for input, such that, without well data or without an image, the channel facies trend mapping engine 110 can generate geological predictions.

The method 200 includes controlling a drilling mechanism using the output of the one or more trained machine learning models (208). For example, the drilling mechanism 126, which can include a drilling rig, can obtain the output data 122. The drilling mechanism 126 can adjust drilling, e.g., to position a drill bit or other drilling element to drill in a particular direction or with a particular active setting based on the geological composition indicated by the output data 122, such as the predicted channel trend mappings.

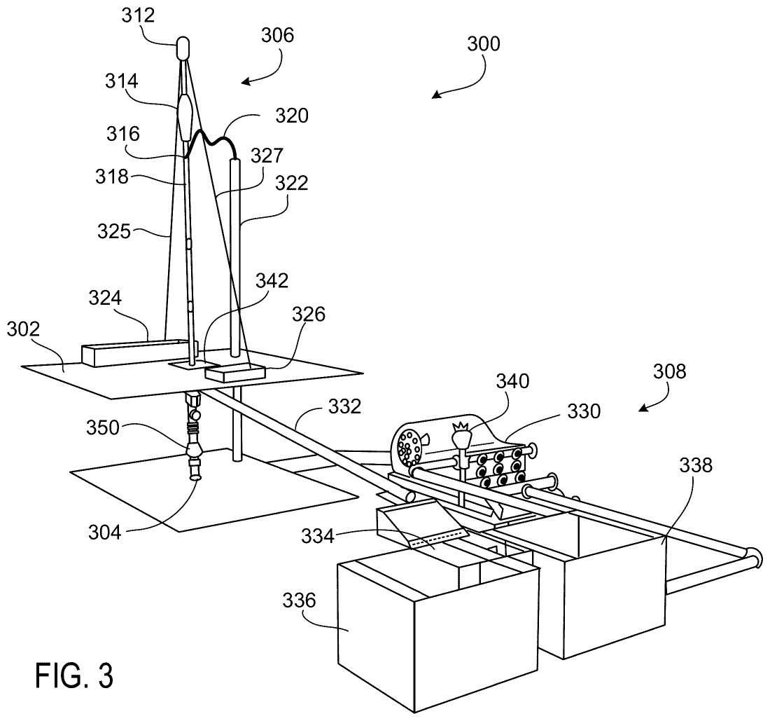

FIG. 3 is a partial schematic perspective view of an example rig system 300 for drilling and producing a well. In some cases, the system 100 can optimize drilling by a rig system similar to the rig system 300, including controlling one or more elements of the rig system 300. The well can extend from the surface through the Earth to one or more subterranean zones of interest. The example rig system 300 includes a drill floor 302 positioned above the surface, a wellhead 304, a drill string assembly 306 supported by the rig structure, a fluid circulation system 308 to filter used drilling fluid from the wellbore and provide clean drilling fluid to the drill string assembly 306. For example, the example rig system 300 of FIG. 3 is shown as a drill rig capable of performing a drilling operation with the rig system 300 supporting the drill string assembly 306 over a wellbore. The wellhead 304 can be used to support casing or other well components or equipment into the wellbore of the well.

The derrick or mast is a support framework mounted on the drill floor 302 and positioned over the wellbore to support the components of the drill string assembly 306 during drilling operations. A crown block 312 forms a longitudinally-fixed top of the derrick, and connects to a travelling block 314 with a drilling line including a set of wire ropes or cables. The crown block 312 and the travelling block 314 support the drill string assembly 306 via a swivel 316, a kelly 318, or a top drive system (not shown). Longitudinal movement of the travelling block 314 relative to the crown block 312 of the drill string assembly 306 acts to move the drill string assembly 306 longitudinally upward and downward. The swivel 316, connected to and hung by the travelling block 314 and a rotary hook, allows free rotation of the drill string assembly 306 and provides a connection to a kelly hose 320, which is a hose that flows drilling fluid from a drilling fluid supply of the circulation system 308 to the drill string assembly 306. A standpipe 322 mounted on the drill floor 302 guides at least a portion of the kelly hose 320 to a location proximate to the drill string assembly 306. The kelly 318 is a hexagonal device suspended from the swivel 316 and connected to a longitudinal top of the drill string assembly 306, and the kelly 318 turns with the drill string assembly 306 as the rotary table 342 of the drill string assembly turns.

In the example rig system 300 of FIG. 3, the drill string assembly 306 is made up of drill pipes with a drill bit (not shown) at a longitudinally bottom end of the drill string. The drill pipe can include hollow steel piping, and the drill bit can include cutting tools, such as blades, discs, rollers, cutters, or a combination of these, to cut into the formation and form the wellbore. The drill bit rotates and penetrates through rock formations below the surface under the combined effect of axial load and rotation of the drill string assembly 306. In some implementations, the kelly 318 and swivel 316 can be replaced by a top drive that allows the drill string assembly 306 to spin and drill. The wellhead assembly 304 can also include a drawworks 324 and a deadline anchor 326, where the drawworks 324 includes a winch that acts as a hoisting system to reel the drilling line in and out to raise and lower the drill string assembly 306 by a fast line 325. The deadline anchor 326 fixes the drilling line opposite the drawworks 324 by a deadline 327, and can measure the suspended load (or hook load) on the rotary hook. The weight on bit (WOB) can be measured when the drill bit is at the bottom the wellbore. The wellhead assembly 304 also includes a blowout preventer 350 positioned at the surface of the well and below (but often connected to) the drill floor 302. The blowout preventer 350 acts to prevent well blowouts caused by formation fluid entering the wellbore, displacing drilling fluid, and flowing to the surface at a pressure greater than atmospheric pressure. The blowout preventer 350 can close around (and in some instances, through) the drill string assembly 306 and seal off the space between the drill string and the wellbore wall.

During a drilling operation of the well, the circulation system 308 circulates drilling fluid from the wellbore to the drill string assembly 306, filters used drilling fluid from the wellbore, and provides clean drilling fluid to the drill string assembly 306. The example circulation system 308 includes a fluid pump 330 that fluidly connects to and provides drilling fluid to drill string assembly 306 via the kelly hose 320 and the standpipe 322. The circulation system 308 also includes a flow-out line 332, a shale shaker 334, a settling pit 336, and a suction pit 338. In a drilling operation, the circulation system 308 pumps drilling fluid from the surface, through the drill string assembly 306, out the drill bit and back up the annulus of the wellbore, where the annulus is the space between the drill pipe and the formation or casing. The density of the drilling fluid is intended to be greater than the formation pressures to prevent formation fluids from entering the annulus and flowing to the surface and less than the mechanical strength of the formation, as a greater density may fracture the formation, thereby creating a path for the drilling fluids to go into the formation. Apart from well control, drilling fluids can also cool the drill bit and lift rock cuttings from the drilled formation up the annulus and to the surface to be filtered out and treated before it is pumped down the drill string assembly 306 again. The drilling fluid returns in the annulus with rock cuttings and flows out to the flow-out line 332, which connects to and provides the fluid to the shale shaker 334. The flow line is an inclined pipe that directs the drilling fluid from the annulus to the shale shaker 334. The shale shaker 334 includes a mesh-like surface to separate the coarse rock cuttings from the drilling fluid, and finer rock cuttings and drilling fluid then go through the settling pit 336 to the suction pit 336. The circulation system 308 includes a mud hopper 340 into which materials (for example, to provide dispersion, rapid hydration, and uniform mixing) can be introduced to the circulation system 308. The fluid pump 330 cycles the drilling fluid up the standpipe 322 through the swivel 316 and back into the drill string assembly 306 to go back into the well.

The example wellhead assembly 304 can take a variety of forms and include a number of different components. For example, the wellhead assembly 304 can include additional or different components than the example shown in FIG. 3. Similarly, the circulation system 308 can include additional or different components than the example shown in FIG. 3.

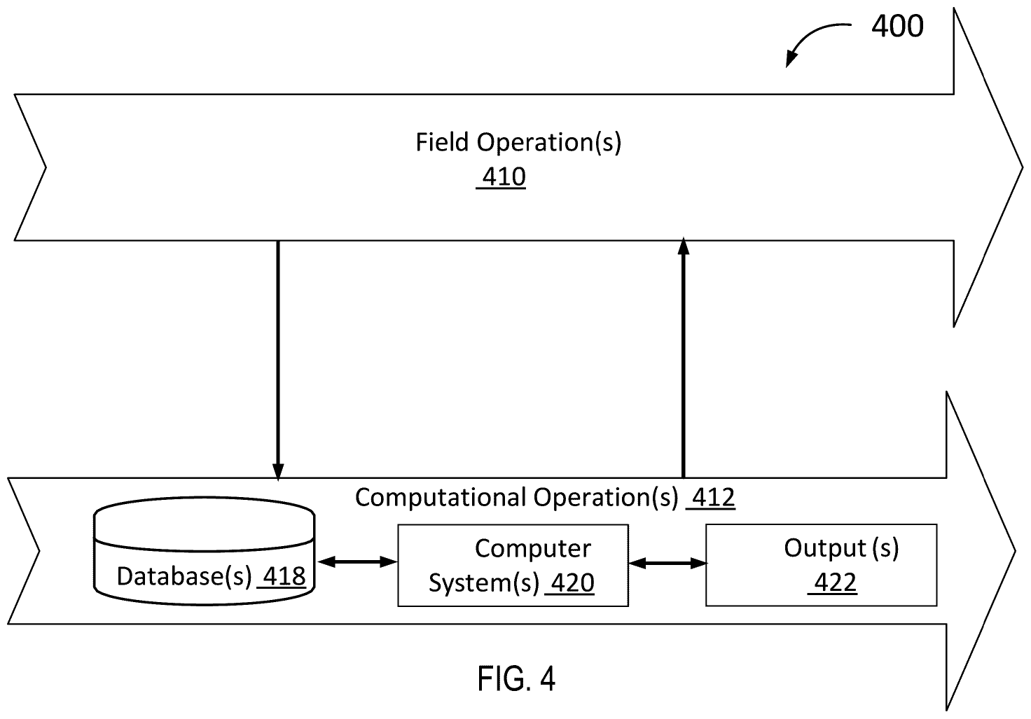

FIG. 4 illustrates hydrocarbon production operations 400 that include both one or more field operations 410 and one or more computational operations 412, which exchange information and control exploration for the production of hydrocarbons. In some implementations, outputs of techniques of the present disclosure can be performed before, during, or in combination with the hydrocarbon production operations 400, specifically, for example, either as field operations 410 or computational operations 412, or both.

Examples of field operations 410 include forming/drilling a wellbore, hydraulic fracturing, producing through the wellbore, injecting fluids (such as water) through the wellbore, to name a few. In some implementations, methods of the present disclosure can trigger or control the field operations 410. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 410 and responsively triggering the field operations 410 including, for example, generating plans and signals that provide feedback to and control physical components of the field operations 410. Alternatively or in addition, the field operations 410 can trigger the methods of the present disclosure. For example, implementing physical components (including, for example, hardware, such as sensors) deployed in the field operations 410 can generate plans and signals that can be provided as input or feedback (or both) to the methods of the present disclosure.

Examples of computational operations 412 include one or more computer systems 420 that include one or more processors and computer-readable media (e.g., non-transitory computer-readable media) operatively coupled to the one or more processors to execute computer operations to perform the methods of the present disclosure. The computational operations 412 can be implemented using one or more databases 418, which store data received from the field operations 410 and/or generated internally within the computational operations 412 (e.g., by implementing the methods of the present disclosure) or both. For example, the one or more computer systems 420 process inputs from the field operations 410 to assess conditions in the physical world, the outputs of which are stored in the databases 418. For example, seismic sensors of the field operations 410 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 412 where they are stored in the databases 418 and analyzed by the one or more computer systems 420.

In some implementations, one or more outputs 422 generated by the one or more computer systems 420 can be provided as feedback/input to the field operations 410 (either as direct input or stored in the databases 418). The field operations 410 can use the feedback/input to control physical components used to perform the field operations 410 in the real world.

For example, the computational operations 412 can process the seismic data to generate three-dimensional (3D) maps of the subsurface formation. The computational operations 412 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 412 to process new information about the formation and control the drilling to adjust to the observed conditions in real-time.

The one or more computer systems 420 can update the 3D maps of the subsurface formation as information from one exploration well is received and the computational operations 412 can adjust the location of the next exploration well based on the updated 3D maps. Similarly, the data received from production operations can be used by the computational operations 412 to control components of the production operations. For example, production well and pipeline data can be analyzed to predict slugging in pipelines leading to a refinery and the computational operations 412 can control machine operated valves upstream of the refinery to reduce the likelihood of plant disruptions that run the risk of taking the plant offline.

In some implementations of the computational operations 412, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

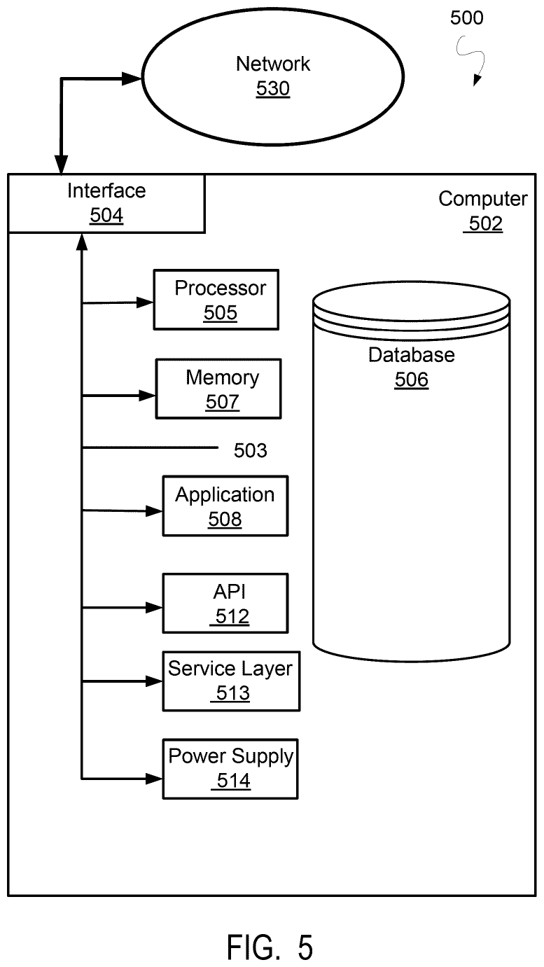

FIG. 5 is a block diagram of an example computer system 500 that can be used to provide computational functionalities associated with described algorithms, methods, functions, processes, flows, and procedures, according to some implementations of the present disclosure. In some implementations, the system 100 can include the computer system 500 or the system 100 can communicate with the computer system 500.

The illustrated computer 502 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI). In some implementations, the inputs and outputs include display ports (such as DVI-I+2x display ports), USB 3.0, GbE ports, isolated DI/O, SATA-III (6.0 Gb/s) ports, mPCIe slots, a combination of these, or other ports. In instances of an edge gateway, the computer 502 can include a Smart Embedded Management Agent (SEMA), such as a built-in ADLINK SEMA 2.2, and a video sync technology, such as Quick Sync Video technology supported by ADLINK MSDK+. In some examples, the computer 502 can include the MXE-5400 Series processor-based fanless embedded computer by ADLINK, though the computer 502 can take other forms or include other components.

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a high level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both), over the system bus. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs 512.

The service layer 513 can provide software services to the computer 502 and other components (whether illustrated or not) that are communicably coupled to the computer 502. The functionality of the computer 502 can be accessible for all service consumers using this service layer 513. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 can include an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and manipulate data to perform the operations of the computer 502, including operations using algorithms, methods, functions, processes, flows, and procedures as described in the present disclosure.

The computer 502 can also include a database 506 that can hold data for the computer 502 and other components connected to the network 530 (whether illustrated or not). For example, database 506 can be an in-memory, conventional, or a database storing data consistent with the present disclosure. In some implementations, the database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

An application 508 can be an algorithmic software engine providing functionality according to particular needs, desires, or particular implementations of the computer 502 and the described functionality. For example, an application 508 can serve as one or more components, modules, or applications 508. Multiple applications 508 can be implemented on the computer 502. Each application 508 can be internal or external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power-supply 514 can include a power plug to allow the computer 502 to be plugged into a wall socket or a power source to, for example, power the computer 502 or recharge a rechargeable battery.

There can be any number of computers 502 associated with, or external to, a computer system including computer 502, with each computer 502 communicating over network 530. Further, the terms “client,” “user,” and other appropriate terminology can be used interchangeably without departing from the scope of the present disclosure. Moreover, the present disclosure contemplates that many users can use one computer 502 and one user can use multiple computers 502.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer using a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A method comprising:
obtaining geological composition data from at least one drilled well within a geographical area;
generating preprocessed data using at least one of (i) the obtained geological composition data or (ii) an image representing the geographical area that preserves first spatial data;
providing the preprocessed data to one or more machine learning models, wherein the one or more machine learning models are trained to predict trend mappings of facies using second spatial data or location-based data; and
controlling a drilling mechanism using the output of the one or more trained machine learning models.

2. The method of claim 1, wherein obtaining the geological composition data from the at least one drilled well within the geographical area comprises:
obtaining data collected during or after drilling in the geographical area.

3. The method of claim 1, wherein generating the preprocessed data comprises:
generating a structured data container with two data dimensions, wherein the two dimensions match the dimensions of the image representing the geographical area;
sampling values from at least one of (i) the obtained geological composition data or (ii) the image representing the geographical area; and
generating values for each of element of the generated structured data container using the sampled values from at least one of (i) the obtained geological composition data or (ii) the image representing the geographical area.

4. The method of claim 1, wherein generating the preprocessed data comprises:
determining a quality of the image representing the geographical area; and
adjusting, based on the determined quality, the image representing the geographical area.

5. The method of claim 1, wherein controlling the drilling mechanism using the output of the one or more trained machine learning models comprises:
providing data indicating the output of the one or more trained machine learning models to one or more computers controlling the drilling mechanism.

6. The method of claim 1, wherein controlling the drilling mechanism using the output of the one or more trained machine learning models comprises:
adjusting a steering direction or operation of the drilling mechanism using the output of the one or more trained machine learning models.

7. The method of claim 1, comprising:
training the one or more machine learning models to predict trend mappings of facies using ground truth data generated by object modeling.

8. The method of claim 1, wherein the second spatial data includes the first spatial data.

9. One or more computer-readable storage media encoded with instructions that, when executed by one or more computers, cause the one or more computers to perform operations comprising:
obtaining geological composition data from at least one drilled well within a geographical area;
generating preprocessed data using at least one of (i) the obtained geological composition data or (ii) an image representing the geographical area that preserves first spatial data;
providing the preprocessed data to one or more machine learning models, wherein the one or more machine learning models are trained to predict trend mappings of facies using second spatial data or location-based data; and
controlling a drilling mechanism using the output of the one or more trained machine learning models.

10. The media of claim 9, wherein obtaining the geological composition data from the at least one drilled well within the geographical area comprises:
obtaining data collected during or after drilling in the geographical area.

11. The media of claim 9, wherein generating the preprocessed data comprises:
generating a structured data container with two data dimensions, wherein the two dimensions match the dimensions of the image representing the geographical area;
sampling values from at least one of (i) the obtained geological composition data or (ii) the image representing the geographical area; and
generating values for each of element of the generated structured data container using the sampled values from at least one of (i) the obtained geological composition data or (ii) the image representing the geographical area.

12. The media of claim 9, wherein generating the preprocessed data comprises:
determining a quality of the image representing the geographical area; and
adjusting, based on the determined quality, the image representing the geographical area.

13. The media of claim 9, wherein controlling the drilling mechanism using the output of the one or more trained machine learning models comprises:
providing data indicating the output of the one or more trained machine learning models to one or more computers controlling the drilling mechanism.

14. The media of claim 9, wherein controlling the drilling mechanism using the output of the one or more trained machine learning models comprises:
adjusting a steering direction or operation of the drilling mechanism using the output of the one or more trained machine learning models.

15. The media of claim 9, wherein the operations comprise:
training the one or more machine learning models to predict trend mappings of facies using ground truth data generated by object modeling.

16. A system comprising:
one or more computers and one or more storage devices on which are stored instructions that are operable, when executed by the one or more computers, to cause the one or more computers to perform operations comprising:
obtaining geological composition data from at least one drilled well within a geographical area;
generating preprocessed data using at least one of (i) the obtained geological composition data or (ii) an image representing the geographical area that preserves first spatial data;
providing the preprocessed data to one or more machine learning models, wherein the one or more machine learning models are trained to predict trend mappings of facies using second spatial data or location-based data; and
controlling a drilling mechanism using the output of the one or more trained machine learning models.

17. The system of claim 16, wherein obtaining the geological composition data from the at least one drilled well within the geographical area comprises:
obtaining data collected during or after drilling in the geographical area.

18. The system of claim 16, wherein generating the preprocessed data comprises:
generating a structured data container with two data dimensions, wherein the two dimensions match the dimensions of the image representing the geographical area;
sampling values from at least one of (i) the obtained geological composition data or (ii) the image representing the geographical area; and
generating values for each of element of the generated structured data container using the sampled values from at least one of (i) the obtained geological composition data or (ii) the image representing the geographical area.

19. The system of claim 16, wherein generating the preprocessed data comprises:
determining a quality of the image representing the geographical area; and
adjusting, based on the determined quality, the image representing the geographical area.

20. The system of claim 16, wherein controlling the drilling mechanism using the output of the one or more trained machine learning models comprises:
providing data indicating the output of the one or more trained machine learning models to one or more computers controlling the drilling mechanism.
